(19) United States
(12) Patent Application Publication
(10) Pub. No.: US 2026/0234849 A1
(43) Pub. Date: Aug. 13, 2026

(54) AMINE-FUNCTIONALIZED CELLULOSE MATERIAL, METHOD FOR PRODUCING SAME, AND USE THEREOF AS CO2 ADSORBER

(71) Applicant: DEUTSCHE INSTITUTE FÜR TEXTIL- UND FASERFORSCHUNG DENKENDORF, Denkendorf (DE)

(72) Inventors: Frank HERMANUTZ, Leonberg (DE); David BOCK, Ostfildern (DE); Carlo J. PANI, Esslingen (DE); Marc P. VOCHT, Stuttgart (DE); Rudolf Michael BUCHMEISER, Remshalden (DE)

(21) Appl. No.: 19/153,047

(22) PCT Filed: Jan. 29, 2024
(86) PCT No.: PCT/EP2024/052085

§ 371 Date: Aug. 1, 2025

(30) Foreign Application Priority Data
Feb. 1, 2023 (DE) 102023102450.7

(51) Int. Cl. D04H 3/013; B01J 20/26; B01J 20/28; B01J 20/32; D06M 15/61; D06M 15/705; D06M 15/71; D06M 15/715; D06M 101/06

(52) U.S. Cl. CPC D04H 3/013; B01J 20/261; B01J 20/28011; B01J 20/28023; B01J 20/3282; D06M 15/61; D06M 15/705; D06M 15/71; D06M 15/715; D06M 2101/06; D10B 2201/20

(57) ABSTRACT

Described is an amine-functionalized cellulose material, which has a cellulose support based on cellulose fibers, which is present in the form of textile sheet structures, and on which a coating composed of a cross-linked polyalkylenamine is formed. This amine-functionalized cellulose material is characterized by high values of CO₂- and water-adsorption capacity. The amine-functionalized cellulose material is produced in particular by a process in which the cellulose support is mixed into an alcoholic solution of a compound crosslinking the polyalkylenamine, and this alcoholic solution is mixed with an alcoholic polyalkylenamine solution.

To start a cross-linking reaction, water is added to this mixture. The resulting amine-functionalized cellulose material is particularly suitable for the direct adsorption of CO₂ from air. This can be followed by desorption of the CO₂ in order to supply it to a useful application, in particular for the production of chemicals and for promoting the growth of plants in greenhouses.

The invention relates to an amine-functionalized cellulose material comprising a cellulose support coated with a crosslinked polyalkylenamine, a process for the preparation thereof, and use thereof for the direct adsorption of CO₂ from air (direct air capture).

According to the current state of the art, cellulose materials in the form of powder, staple fibers, and textiles are already being functionalized with amine-con-taining compounds, wherein both monomers and polymers are used. The process according to EP 3 878 550 A1 is based on the oxidation of cellulose, which results in an oxidized cellulose polymer. The cellulose can be in powder or textile form here. In particular, laccase and 2,2,6,6-tetramethylpiperidine-1(oxyl) (TEMPO) or NaClO are used as oxidizing agents. The oxidized cellulose material is then functionalized with polyalkylenamines, such as polyethylenimine (correctly polyethylenamine), tetraethylenepentamine, diethylenetriamine, pentaethylenehexamine, wherein the amine-functionalized cellulose polymer can optionally be brought into contact with a dialdehyde. When the oxidized cellulose polymer is reacted with polyalkylenamine, a coupling agent is present. For use as DAC (direct air capture) materials, they are employed in the form of textiles or also as bulk material (powder). The amine functionalization of the oxidized cellulose materials is only possible in batch operation, which is time-consuming.

In powder form, the known amine-functionalized cellulose material has a high bulk density, which is characterized by poor air permeability, whereby the energy consumption during adsorption and desorption is increased. The known process is also said to be related to various steps of combining the amine-functionalized polymer, such as with a binder. This results in a surface finishing solution. A textile is treated with this solution. If necessary, the surface of the treated textile is subjected to cross-linking. The known powdery and textile CO₂ adsorbers only have a low adsorption capacity of up to 0.46 mmol/g material. The amount of CO₂ recovered is too small for this adsorber to be used in large-scale DAC processes or for downstream processing of the desorbed CO₂ into fuels, or for final storage. Based on the prior art specified above, the invention is based on the task of proposing an amine-functionalized cellulose material which contains cellulose as a support, but shows a significantly improved CO₂ adsorption capacity and also an improvement in the desorption of the CO₂ in order to supply it to useful applications. Further, a good water adsorption capacity should be achieved. In particular, an advantageous process for the production of an improved amine-functionalized cellulose material is to be proposed, which can be carried out in an economically and technically advantageous manner and, in particular, does not require the surface of the cellulose materials used as supports to be chemically pretreated at great expense, for example with an oxidizing agent.

This task is solved by an amine-functionalized cellulose material comprising cellulose as a support, which is coated with a crosslinked polyalkylenamine, characterized in that the cellulose support is based on cellulose fibers which are present in the form of textile sheet structures.

According to the invention, it is preferred if the cellulose fiber of the textile sheet structure is present as a microfiber, in particular as a continuous fiber. Thus, the fiber is preferably a round fiber, the diameter of which is in particular between about 4 and about 20 μm and particularly preferably between about 6 and 12 μm, or a trilobal fiber, the dtex value of which is in particular between about 2 and 5 dtex and particularly preferably between about 2.5 and 3.5 dtex.

In the textile sheet structures according to the invention, the fiber is present in particular as a nonwoven (fleece), wherein the weight per unit area of the nonwoven ranges particularly from about 150 to 600 g/m² and particularly preferably from about 250 to 440 g/m², and/or the thickness of the nonwoven ranges particularly from about 0.5 to 15 mm, particularly preferably from approximately 0.7 to 13 mm.

With regard to the origin of the cellulose fibers used as support material according to the invention, the invention is not subject to any significant limitations.

The fibers may be natural cellulose fibers, such as hemp fibers, jute fibers, linen fibers, cotton, but also regenerated cellulose fibers, such as lyocell and viscose fibers. The fibers are preferably present in the textile sheet structures in the form of woven fabrics, warp-knitted fabrics, laid fabrics, knitted fabrics, and nonwoven material, in particular as a nonwoven. The viscose fiber is preferred. In principle, natural fibers may be considered, such as cotton.

The degree of polymerization of the cellulose material is not of particular importance. To give a rule here, the molecular weight could preferably be about 200 to 3500, in particular about 250 to 3000.

In the context of the invention, the cellulose fiber as a support is treated with a combination of a polyalkylenamine and a suitable crosslinker for this purpose according to the process to be described below: The polyalkylenamine is preferably linear, branched, cyclic, or dendritic. Preferably, a polyethylenimine (PEI), polypropyleneamine, polybutyleneamine, polypentyleneamine, tetraethylenepentamine (TEPA), diethylenetriamine (DETA), and/or pentaethylenehexamine (PEHA) is used as the polyalkylenamine.

It should be noted that the above-specified cellulose fibers must not be treated in any relevant way, but should preferably be left in their pure form so as not to jeopardize the technical success sought by the invention. In particular, there should be no chemical modification of the cellobiose unit (glucose dimer) within the structure of the cellulose. This would also mean a considerable additional technical effort and would mean that the coating of the cellulose support required according to the invention would not lead to the desired effects. This applies to the prior art according to EP 3 878 850 A, which proposes a disadvantageous modification according to which the cellulose (cellobiose unit) is first subjected to oxidation, resulting in an oxidized cellulose polymer, which is converted into an amine-functionalized cellulose polymer via a special reaction. This procedure only achieves adsorption capacities of up to 0.46mmol_{CO2}/g_{adsorbent}.

Attention should be paid to the molecular weight of the polyalkylenamine used according to the invention: Thus, it has been shown that the polyalkylenamine preferably has a molecular weight of 600 to 100,000, in particular of about 1,000 to 50,000, most preferably of about 1,500 to 30,000.

In a particular embodiment of the invention, it is suitable to use certain advantageous crosslinkers for the polyalkylenamines in order to employ them in the crosslinking according to the invention, which will be described in detail later.

Said crosslinker is preferably a dialdehyde, a diketone, a dicarboxylic acid, a dicarboxylic acid salt, and/or a dicarboxylic acid halide, in particular dicarboxylic acid chloride. It is particularly preferred that the crosslinked polyalkylenamine, in particular the polyethylenamine, is based on a crosslinking of polyalkylenamine with a dialdehyde of the formula CHO(CH₂)ₙCH₂CHO, wherein n is an integer between 2 and 9, in particular between 2 and 6, in particular in the form of oxaldialdehyde, glutardialdehyde, aldipindialdehyde, succindialdehyde, malondialdehyde, and/or 1,9-nonandialdehyde. Glutardialdehyde is particularly preferred here.

In a further advantageous embodiment of the invention, the coating of the cellulose support with crosslinked polyalkylenamine has a thickness of about 1.0 to 10 μm, in particular of about 1.0 to 10.5 μm.

The particular advantages that can be achieved with the present invention are shown in the surprisingly increased CO₂ adsorption capacity of preferably about 0.6 to 2.0 mmol_{CO2}/g_{adsorbent}, in particular of about 0.8 to 1.9 mmol_{CO2}/g_{adsorbent}, compared to the prior art, and in a very favorable H₂O adsorption capacity of preferably about 15 to 35% by weight, in particular of 20 to 30% by weight. In principle, the amine-functionalized cellulose material according to the invention is also advantageous if it has a CO₂ adsorption capacity of at least about 0.50 mmol_{CO2}/g_{adsorbent}, preferably of at least about 0.6 mmol_{CO2}/g_{adsorbent}, in particular of at least about 0.7 mmol_{CO2}/g_{adsorbent}, and most preferably of at least about 0.8 mmol_{CO2}/g_{adsorbent}. The same applies if the amine-functionalized cellulose material (adsorbent) has a CO₂ adsorption capacity of at most about 3.0 mmol_{CO2}/g_{adsorbent}, preferably of at most about 2.4 mmol_{CO2}/g_{adsorbent}, in particular of at most about 2.0 mmol_{CO2}/g_{adsorbent}, and particularly preferably of at most about 1.9 mmol_{CO2}/g_{adsorbent}.

The key to the success sought according to the invention as described above also lies in the improved processes A and B for producing the amine-functionalized cellulose material according to the invention, which are described in more detail below:

The process A according to the invention for the production of the described amine-functionalized cellulose material is characterized in that 1) the cellulose support is added to an alcoholic, in particular ethanolic, solution of a compound crosslinking the polyalkylenamine, the crosslinking compound being at least bifunctional with respect to the crosslinking reaction, 2) the polyalkylenamine is added to an alcoholic, in particular ethanolic, solution, and 3) the alcoholic solutions from step 1) and step 2) are mixed, 4) water is added to the obtained mixture, in particular in an amount of about 10 to 40% by weight, based on the total reaction system, to start a crosslinking reaction, whereby a layer of a crosslinked polyalkylenamine is formed on the cellulose support, and 5) after completion of the crosslinking reaction, the amine-functionalized cellulose material is obtained. With regard to the choice of a suitable alcohol, the present invention is not subject to any critical limitation. In principle, alcohols with 1 to 6 carbon atoms can be used, in particular methanol, ethanol, propanol, butanol, pentanol, and/or hexanol. Ethanol is particularly preferred from a variety of points of view. It can be used to achieve the object of the invention in an optimal way.

In principle, it is also possible to convert the two steps 1) and 2) above into a single step, according to which the three components mentioned above are simultaneously introduced into an alcoholic solution, in particular an ethanolic solution. However, this involves the risk that step 4), which is intended to initiate the cross-linking reaction, is at least partially anticipated. This could result in the desired properties of the process product in the form of the amine-functionalized cellulose material not being achieved to the desired extent.

Insofar as the following description of the process A according to the invention, which is a batch process, but also of the continuous padder process B, which is to be dealt with later, refers to special chemical compounds, these are the same as those already dealt with above in connection with the amine-functionalized cellulose material according to the invention. When speaking of alcohol, the invention is not subject to any relevant limitations. In particular, said alcohol may be methanol, ethanol, butanol, propanol, and the like, with ethanol being preferred.

The amount of the respective alcohol which is advantageous in the specified steps 1), 2), and 3) is about 10 to 95, preferably about 30 to 75, in particular about 45 to 65% by weight of alcohol in the respective solution.

The water is preferably supplied in step 4) in such an amount that about 1 to 5 parts by weight of alcohol, in particular about 3 to 4 parts by weight of alcohol, in particular ethanol, are present per 1 part by weight of water. The information on the choice of alcohol, as above, also applies here.

The temperature can be considered in order to optimize the process according to the invention during crosslinking. The crosslinking reaction is suitably carried out at a temperature of about 15° C. to 50° C., in particular about 20 to 30° C.

The method according to the invention is advantageously further developed as follows: Drying of the process product is carried out under vacuum. Here, the amine-functionalized cellulose material is preferably dried at an elevated temperature of about 20° C. to 100° C., in particular from about 50° C. to 70° C., preferably under a vacuum of about 20 mbar to 300 mbar, in particular from about 50 mbar to 150 mbar. According to the invention, a vacuum drying oven is preferably used to carry out these drying measures.

The temperature plays an optimizing role in the further treatment of the process product according to the invention in the form of the amine-functionalized cellulose material: Thus, it is advantageous if the amine-functionalized cellulose material is washed at about 40° C. to 80° C., in particular about 50° C. to 70° C., in particular with water and/or ethanol. It is preferable to carry out a drying again after-wards. The procedure specifically is as follows: The drying is preferably carried out at an elevated temperature of about 40° C. to 80° C., in particular from about 50° C. to 70° C., preferably under a vacuum of about 50 mbar to 250 mbar, in particular from about 100 mbar to 200 mbar. This is preferably done using the vacuum drying oven specified above.

Surprisingly, it is advantageous if the washing is carried out in two steps, the first step being washing with water and the second step with alcohol, in particular ethanol, in order to remove unreacted polyalkylenamine. Drying is then preferably carried out at an elevated temperature, in particular at about 50° C. to 70° C. The range from about 55° C. to 65° C. is particularly preferred.

Further embodiments of the invention, which can be easily integrated into the method teaching according to the invention, are to be described as follows:

It is very useful if about 5 to 50 parts by weight, in particular about 10 to 25 parts by weight, of polyalkylenamine are present per 1 part by weight of cross-linking compound (crosslinker). Moreover, the liquor ratio should be suitably opti-mized. This occurs when the liquor ratio of cellulose support to the remaining coating composition batch (alcohol, crosslinker, polyalkylenamine) is about 1:20 to 1:100, in particular about 1:60 to 1:80.

The amine-functionalized cellulose material according to the invention can be produced particularly advantageously using the continuously operated padder process B, in which the coating mass is continuously applied to the cellulose support in the form of a textile sheet structure, in particular to a nonwoven. Before the relevant method teaching according to the invention is described in detail, the special features of the padding process with regard to the present invention will be described:

Foulard application, padding, or full-bath impregnation refers to a process for the wet treatment of textile sheet structures (woven fabrics, knitted fabrics, non-woven fabrics, and the like) on a padding machine. In this process, the textile sheet structure is continuously impregnated and generally passed through a pair of rollers to partially press off the liquor.

The liquor is located in an upstream trough or a padder (i.e., padding bath) or upstream of a pair of rollers related to the padder machine. The finished and impregnated textile sheet structure is squeezed off to a precisely defined level of excess liquor using the pair of rollers of the padder machine. The amount of liquor absorbed is given as a percentage of the gross weight of the respective textile sheet structure, in particular the nonwoven. A liquor pick-up or remaining liquor (after pressing off with the pair of rollers) of 20% means that there is 20 g of liquor per 100 g of raw textile sheet structure. In this case, padding is followed by a drying process, in particular in a vacuum drying oven, and a subsequent washing process. Therefore, the following can be generally stated about the continuous method teaching according to the invention, according to the padding process:

1. The textile sheet structure, in particular the nonwoven fabric, is first impregnated with an alcoholic crosslinker solution, in particular glutardialdehyde solution, and then (while still wet) impregnated with an alcoholic, in particular ethanolic, polyalkylenamine solution, or the two steps shown are reversed in sequence (2 impregnation steps in total). After the respective impregnation, the liquor is partially pressed or squeezed off with the pair of rollers of the padder machine. 2. The textile sheet structure is impregnated with a single alcoholic, in particular ethanolic, solution, wherein this solution contains both the crosslinker and the polyalkylenamine. Hence, the liquor or impregnating solution contains both reactants. Impregnation is carried out at least once here. However, a double impregnation can offer advantages. The above-mentioned pressing off or squeez-ing off of the impregnated textile sheet structure with the pair of rollers is always carried out. The subsequent steps of drying and/or washing are largely the same. Taking into account the above explanatory remarks on the padding preferred according to the invention, this can be represented as follows in the embodiment of a further advantageous method B according to the invention:

Accordingly, the object of the invention is furthermore a process B for producing the amine-functionalized cellulose material described above, which has a textile sheet structure as cellulose support, in particular in the form of a nonwoven, and which is characterized in that 1 the textile sheet structure is impregnated with an alcoholic, in particular ethanolic, solution of a polyalkylenamine crosslinking compound (crosslinker), in particular in the form of glutardialdehyde, in the padding bath of a padder machine, and the textile sheet structure impregnated in this way is pressed off in a subsequent pair of rollers of the padder machine, and 2 the wet, impregnated textile sheet structure of step 1 is then impregnated with an alcoholic, in particular ethanolic polyalkylenamine solution, in particular a polyethylenimine solution, in a further padding bath of the padder machine, and 3 said impregnated textile sheet structure obtained after steps 1 and 2 is pressed off over a further pair of rollers of the padder machine to a liquor pick-up of about 20 to 50% by weight, in particular of about 35 to 45% by weight, and 4 the crosslinking reaction between the crosslinker and the polyalkylenamine is then effected, if necessary with heating, to form a layer of crosslinked polyalkylenamine on the surface of the textile sheet structure.

In step 4, the crosslinking reaction starts as soon as sufficient alcohol, in particular ethanol, has evaporated. After completion of the crosslinking reaction, the specified layer of crosslinked polyalkylenamine is then present on the surface of the textile sheet structure. To promote step 4, said step is carried out at an elevated temperature of about 40 to 80° C., in particular about 50 to 70° C., and especially preferably about 60° C. Another advantageous further development of step 4 is that a vacuum is applied for its implementation, in particular from about 50 to 250 mbar, particularly preferably from about 100 to 200 mbar.

It is particularly advantageous if the pairs of rollers of the padder machine are operated at a speed of about 0.2 to 5 m/min, in particular about 0.5 to 2 m/min, and most preferably about 1 m/min, and/or the contact pressure of the rollers is set between about 0.2 and 5 bar, in particular between about 0.5 and 2.5 bar, most preferably to about 1 bar. The mass fraction of crosslinker for polyalkylenamine in the respective liquor is important as well. It is preferred that the mass fraction of crosslinker, in particular glutardialdehyde, in the liquor of step 1 is about 0.3 to 6% by weight, in particular about 1 to 3% by weight, and particularly preferably about 2% by weight, and/or the mass fraction of polyalkylenamine in the liquor of step 2 is about 3 to 18% by weight, in particular about 7 to 14% by weight, and particularly preferably about 10% by weight.

In individual cases, it is advantageous to reorganize steps 1 and 2. The technical teaching would therefore be characterized in that 1 the textile sheet structure is impregnated in the padding bath of a padder machine with an alcoholic, in particular ethanolic, polyalkylenamine solution, and the textile sheet structure impregnated in this way is pressed off in a subsequent pair of rollers of the padder machine, and 2 the wet, impregnated textile sheet structure of step 1 is then impregnated in a further padding bath of a padder machine with an alcoholic, in particular ethanolic, solution of a polyalkylenamine-crosslinking compound (crosslinker), in particular in the form of glutardialdehyde. This would be followed by the further steps of the above-mentioned method teaching of the invention.

In individual cases, it may also be advantageous to combine steps 1 and 2 and to treat the textile sheet structure with an impregnating solution containing the re-quired reactants, and to subject the impregnated textile sheet structure to steps 3 and 4 to form the amine-functionalized cellulose material. The liquor ratio of the textile sheet structure to the rest of the coating composition batch plays an optimizing role as well: It is therefore suitable for the liquor ratio of textile sheet structure to the remaining coating composition batch (alcohol, crosslinker, polyalkylenamine) to be about 1:20 to 1:100, in particular about 1:60 to 1:80.

It is advantageous if the weight ratio of crosslinking compound (crosslinker) and polyalkylenamine is taken into consideration. The process B according to the invention is therefore preferably further embodied if about 5 to 50 parts by weight, in particular about 10 to 25 parts by weight, of polyalkylenamine are present per 1 part by weight of crosslinking compound (crosslinker).

The particular advantage of the invention becomes apparent when the amine-functionalized cellulose material according to the invention is used for the direct adsorption of CO₂ from air (direct air capture), as described above. It is particularly suitable if the amine-functionalized cellulose material is used in the form of textile tapes or textile sheet structures, in particular in the form of a nonwoven, for continuous adsorption of CO₂, in particular at room temperature of about 20° C.

The use teaching according to the invention is not only aimed at adsorbing CO₂ to a high degree. The particular advantage of the invention lies in the combination of adsorption/desorption. The adsorbed CO₂ bound to the amine-functionalized cellulose material can be conveniently desorbed and put to useful uses. In this context, it is advantageous if the amine-functionalized cellulose material is subjected to desorption of CO₂ with heating, preferably at a temperature of up to about 100° C., in particular from about 60° C. to 85° C., particularly preferably from about 75° C. to 85° C., in order to subsequently supply the desorbed CO₂ to a useful application which can be determined by a skilled person. Desorption can be pro-moted by applying a reduced pressure of 100 mbar to 900 mbar, in particular from 200 mbar to 800 mbar, and especially preferably from 400 mbar to 600 mbar, with or without an increase in temperature. When speaking of useful applications of the amine-functionalized cellulose material according to the invention, it is in particular a matter of further processing the desorbed CO₂ into chemicals, in particular fuels and plastics, or of promoting the growth of plants in greenhouses.

As a result, the present invention relates to an advantageous amine-functionalized cellulose material that exhibits unusually high values of CO₂ and H₂O adsorption capacity. These values are significantly higher than those achieved with the technology of the state of the art described above. While this only achieves a CO₂ adsorption capacity of 0.46 mmol_{CO2}/g_{adsorbent}, the corresponding values according to the invention easily reach up to about 3 mmol_{CO2}/g_{adsorbent}r, suitably up to about 2 mmol_{CO2}/g_{adsorbent}. In this context, please refer to the explanations above. The CO₂ adsorption capacity that can be achieved according to the invention advantageously ranges up to 35% by weight.

It is advantageous that untreated cellulose fibers, in particular in the form of continuous fibers with different cross-sections (round, trilobal), in the form of textile sheet structures, such as woven fabrics, warp-knitted fabrics, laid fabrics, knitted fabrics, and in particular nonwovens, are used as starting material for the implementation of the present invention. Their modification to amine-functionalized cellulose material is carried out with various polyalkylenamines, with polyethylenimine (PEI) being preferred.

The preferred PEI can be used as a branched or linear polymer with different molecular weights (Mw) between 2,000 and 25,000. The PEI is fixed to the fiber material by means of a chemical reaction. Advantageous chemical crosslinkers, in particular the above-mentioned difunctional aldehydes, are employed for this purpose. Glutardialdehyde is particularly preferred here. Due to the open structure and the good ratio of volume to surface area of the advantageously used nonwoven materials, the energy required to flow CO₂-loaded air through these materials can be significantly reduced. The cellulose support material used according to the invention improves the properties of the adsorber and also protects against mechanical abrasion. The shape of the materials can be adapted as required to different modules, i.e., round or square in length, width, thickness, and shape. The CO₂ adsorption capacity is in particular ≥1.1 mmol_{CO2}/g_{adsorbent}, but can advantageously also be as high as 3.0 mmol_{CO2}/g_{adsorbent}, and is therefore highly suitable for DAC (direct air capture) and downstream processes. The ability of the adsorber according to the invention to additionally bind water considerably improves its possible applications, since the water can be used for further process steps, e.g., for the subsequent production of fuels or, where appropriate, for sub-sequent final storage.

Further particular advantages that characterize the present invention: Continuous cellulose fibers can be produced in large quantities and through various industrial processes, and can be adapted to their use. In comparison to the treatment of powders, staple fibers, or textiles according to the TEMPO process described above, in which the cellulose material must first be oxidized in a batch operation and is only functionalized in an additional step, functionalization of nonwovens, for example, can be carried out according to the invention in a continuous process, in particular with a padder process. This significantly facilitates upscaling and can easily be transferred to existing processes.

In the following examples, several types of fibers are used, which are chemical fibers made from regenerated cellulose. The fiber types differ in the fiber cross-section, which can particularly be either round or trilobal, but also in the fiber diameter, which is preferably between 6 and 12 μm, particularly between 8 and 10 μm. The trilobal fibers are characterized by a particularly high water retention capacity, which can be used to advantage in various applications.

The cellulose fibers or regenerated cellulose fibers can be processed into nonwovens (VS), which are advantageous here, using mechanical processes. The thickness of the nonwoven (VS) varies advantageously between about 0.5 and 15 mm, in particular between about 0.7 and 13 mm, and in individual cases particularly advantageously between about 0.7 and 1.2 mm, while the fabric weight per unit area is preferably between about 250 and 440 g/m², in particular between about 250 and 400g/m². In its particular embodiment, the process according to the invention relates to the use of nonwoven fabrics (VS), which are converted according to the invention into the amine-functionalized cellulose material. After their functionalization, a weight increase of 30 to 150% can be observed. The water absorption of the VS material ranges from 20 to 35%.

The process of adsorption and desorption is addressed in the following examples: Adsorption and desorption processes are investigated using the so-called thermogravimetry. Thermogravimetry is an analysis method that can be used to examine and measure physical and chemical phenomena. For measurement, the samples are placed in a crucible and continuously measured using an integrated balance. This is continuously flushed with nitrogen from below to prevent the condensation of water from humid gases. To determine the adsorption capacity, 40 mg of the material is heated to 80° C. at a heating rate of 10° C./min, kept constant for 30 min, and flushed with a nitrogen volume flow of 200 ml/min. The first heat-up is used for sample preparation, wherein already adsorbed CO₂ and H₂O are desorbed. The sample is then cooled to 25° C. and maintained at this temperature for 60 minutes. This is followed by adsorption at isothermal conditions (25° C.) under a constant volume flow of humid (60% RH) adsorption air of 200 ml/min for 10 hours. Desorption is carried out at the same volume flow rate at 80° C. within 2 h.

Since the adsorbed amounts of CO₂ are not determined gravimetrically due to the binary adsorption of CO₂ and H₂O, the adsorbed CO₂ is determined during desorption with an Emerson X-Stream Enhanced XEGP (see Marc P. Vocht et al., in “Macromol. Mater. Eng.”, 2022, 307, 223093, p. 1-19, there 2.2. Methods). The H₂O adsorption capacity is also determined using the aforementioned thermogravimetry. The difference in material weight before and after adsorption is determined.

The invention is to be explained below in more detail with reference to various examples:

### Example 1

The production of an amine-functionalized cellulose material according to the invention is described, in which a nonwoven fabric (VS) is used as the cellulose support. The finish and reaction are carried out in a batch process in immersion baths (30 cm×30 cm×5 cm). For functionalization with a branched poly(ethylenimine) (b PEI), a nonwoven fabric (thickness 0.7 mm) consisting of round regenerated cellulose fibers (diameter 12 μm/dtex value: 1.7) is provided and washed with ethanol. The nonwoven fabric is soaked for 15 minutes in a 2 wt. % ethanolic glutardialdehyde solution. A 10 wt. % ethanolic bPEI solution (molecular weight 25,000) is then added to this solution. This is then allowed to rest for 30 minutes. Water is added (20% by weight of water to the total mass of the solution) to start the reaction. The nonwovens are stored in the reaction solution at room temperature for 24 hours. The weight ratio of the nonwoven fabric (VS) to the reaction solution is 1:70. The nonwoven is then dried at 60° C. under reduced pressure (<200 mbar). To remove unreacted b PEI, it is then washed with water and ethanol and dried again (60° C., <200 mbar). The CO₂ adsorption is 48 mmol_{CO2}/g_{adsorbent} (1.1 mmol_{CO2}/g_{adsorbent}), and the H₂O adsorption is 18% by weight.

### Example 2

Example 1 is reproduced. The production of the amine-functional cellulose material according to the invention is also carried out using a nonwoven fabric (VS). The molecular weight of the PEI is reduced to 10,000. The CO₂ adsorption of the adsorber obtained is 56 mmol_{CO2}/g_{adsorbent} (1.3 mmol_{CO2}/g_{adsorbent}), and the H₂O adsorption is 24% by weight.

### Example 3

Example 1 is reproduced. The production of the amine-functional cellulose material according to the invention is also carried out using a nonwoven fabric (VS).

The molecular weight of the PEI is reduced to 2,000. Here, a microfiber nonwoven (0.5 dtex) is used to produce the amine-functionalized cellulose material according to the invention. The CO₂ adsorption of the adsorber obtained is 66 mmol_{CO2}/g_{adsorbent} (1.5 mmol_{CO2}/g_{adsorbent}), and the H₂O adsorption is 21% by weight.

### Example 4

The production of an amine-functionalized cellulose material according to the invention is described. The manufacturing is performed using microfiber nonwovens (0.5 dtex). The procedure is carried out as described in example 1 using bPEI (molecular weight: 25,000). The CO₂ adsorption of the adsorber is 68 mmol_{CO2}/g_{adsorbent} (1.5 mmol_{CO2}/g_{adsorbent}), and the H₂O adsorption is 20% by weight.

### Example 5

Here, the amine-functionalized cellulose material according to the invention is obtained using microfiber nonwovens (0.5 dtex). The procedure is carried out as described in example 1 using bPEI (molecular weight: 10,000). The CO₂ adsorption of the adsorber obtained is 53 mmol_{CO2}/g_{adsorbent} (1.2 mmol_{CO2}/g_{adsorbent}), and the H₂O adsorption is 17% by weight.

### Example 6

The production of the amine-functionalized cellulose material according to the invention is carried out using a nonwoven with microfibers (0.5 dtex). The procedure is carried out as described in example 1 using bPEI (molecular weight: 2,000). The CO₂ adsorption of the material obtained is 73 mmol_{CO2}/g_{adsorbent} (1.7 mmol_{CO2}/g_{adsorbent}), and the H₂O adsorption is 25% by weight.

Example 7

Here, the production of the amine-functionalized cellulose material according to the invention is carried out using a nonwoven fabric with trilobal fibers (2.2 dtex). The procedure is carried out as described in example 1 using bPEI (molecular weight: 25,000). The CO₂ adsorption of this material is 48 mmol_{CO2}/g_{adsorbent} (1.1 mmol_{CO2}/g_{adsorbent}), and the H₂O adsorption is 16% by weight.

### Example 8

The production is carried out using a fiber nonwoven made of trilobal fibers (2.2 dtex). The procedure is carried out as described in example 1 using bPEI (molecular weight: 10,000). The CO₂ adsorption is 55 mmol_{CO2}/g_{adsorbent} (1.2 mmol_{CO2}/g_{adsorbent}), and the H₂O adsorption is 16% by weight.

### Example 9

As starting materials, fiber nonwovens made of trilobal fibers (2.2 dtex) are used here as cellulose supports. The procedure is carried out as described in example 1 using bPEI (molecular weight: 2,000). The CO₂ adsorption here is 65 mmol_{CO2}/g_{adsorbent} (1.5 mmol_{CO2}/g_{adsorbent}), and the H₂O adsorption is 23% by weight.

### Example 10

The production of an amine-functionalized cellulose material according to the invention is described. The production is carried out using fiber nonwovens made from trilobal fibers (2.2 dtex). The procedure is carried out as described in example 1 using bPEI (molecular weight: 25,000). The concentration of the crosslinker in the form of glutardialdehyde was 1% by weight. The CO₂ adsorption of this material is 47 mmol_{CO2}/g_{adsorbent} (1.1 mmol_{CO2}/g_{adsorbent}), and the H₂O adsorption is 20% by weight.

### Example 11

For the production of the amine-functionalized cellulose material according to the invention, fiber nonwovens made of trilobal fibers (2.2 dtex) are used. The procedure is carried out as described in example 1 using bPEI (molecular weight: 25,000). The concentration of the crosslinker in the form of glutardialdehyde was 3% by weight. The CO₂ adsorption of this material is 42 mmol_{CO2}/g_{adsorbent} (1.0 mmol_{CO2}/g_{adsorbent}), and the H₂O adsorption is 18% by weight.

### Example 12

The production of an amine-functionalized cellulose material according to the invention is described, in which a nonwoven fabric (VS) is used as the cellulose support. Finishing is carried out in a continuous process by means of a padding machine. For functionalization with a branched poly(ethylenimine) (bPEI), a nonwoven fabric (thickness 0.7 mm) consisting of round regenerated cellulose fibers (diameter 12 μm/dtex value: 1.7) is provided and washed with ethanol. The nonwoven is impregnated on the padding machine at a roller speed of 1 m/min and a contact pressure of 1 bar with a 2 wt. % ethanolic glutardialdehyde solution at room temperature. The still wet nonwoven impregnated with glutardialdehyde solution is then impregnated a second time with a 10 wt. % ethanolic bPEI solution (molecular weight 25,000) under the same conditions. The liquor pick-up of the nonwoven is about 40%. The nonwoven is then dried under normal conditions (laboratory conditions), preferably at a temperature of about 60° C. under a vacuum of about 150 mbar. The cross-linking reaction starts as soon as sufficient ethanol has evaporated. To remove unreacted bPEI, the fabric is then washed with water and ethanol, and dried again under normal conditions (laboratory conditions), in particular at a temperature of about 60° C. under a vacuum of about 150 mbar.

### Example 13 (Reversing the Liquor Load)

The production of an amine-functionalized cellulose material according to the invention is described, in which a nonwoven fabric (VS) is used as the cellulose support. Finishing is carried out in a continuous process by means of a padding machine. For functionalization with a branched poly(ethylenimine) (bPEI), a nonwoven fabric (thickness 0.7 mm) consisting of round regenerated cellulose fibers (diameter 12 μm/dtex value: 1.7) is provided and washed with ethanol. The nonwoven is impregnated on the padding machine at a roller speed of 1 m/min and a contact pressure of 1 bar with a 10 wt. % ethanolic bPEI solution (molecular weight 25,000) at room temperature. The still wet nonwoven impregnated with bPEI solution is then impregnated a second time with a 2 wt. % ethanolic glutardialdehyde solution under the same conditions. The liquor pick-up of the nonwoven is around 40%. Drying of the nonwoven is then carried out at a temperature of about 60° C. under a vacuum of about 150 mbar. The cross-linking reaction starts as soon as sufficient ethanol has evaporated. To remove unreacted bPEI, the fabric is then washed with water and ethanol, and dried again under normal conditions (laboratory conditions), in particular at a temperature of about 60° C. under a vacuum of about 150 mbar.

### Example 14

The production of an amine-functionalized cellulose material according to the invention is described, in which a nonwoven fabric (VS) is used as the cellulose support. Finishing is carried out in a continuous process by means of a padding machine. For functionalization with a branched poly(ethylenimine) (bPEI), a nonwoven fabric (thickness 0.7 mm) consisting of trilobal regenerated cellulose fibers (μm/dtex value: 3.3) is provided and washed with ethanol. The nonwoven is impregnated on the padding machine at a roller speed of 1 m/min and a contact pressure of 1 bar with an ethanolic solution containing 2% by weight of glutardialdehyde and 12.5% by weight of bPEI solution (molecular weight 10,000) at room temperature. This impregnation process can be repeated at will, although two rep-etitions are preferred. The liquor pick-up of the nonwoven is about 42%. %. Drying of the nonwoven is then carried out preferably at a temperature of about 60° C. under a vacuum of about 150 mbar. The cross-linking reaction starts as soon as sufficient ethanol has evaporated. To remove unreacted bPEI, the fabric is then washed with water and ethanol, and dried again at a temperature of about 60° C. and under a vacuum of about 150 mbar.

1-33. (cancel)

34. An amine-functionalized cellulose material comprising a cellulose support coated with a crosslinked polyalkylenamine, characterized in that the cellulose support is based on cellulose fibers which are present in the form of textile sheet structures, and that the crosslinked polyalkylenamine is a result of a crosslinking of polyalkylenamine with a dialdehyde.

35. The amine-functionalized cellulose material according to claim 34, characterized in that the fiber of the textile sheet structure is present as a microfiber.

36. The amine-functionalized cellulose material according to claim 34, characterized in that the fiber is a round fiber, the diameter of which is between about 4 and about 20 μm and particularly preferably between about 6 and 12 μm, or a trilobal fiber, the dtex value of which is between about 2 and 5 dtex.

37. The amine-functionalized cellulose material according to claim 34, characterized in that the cellulose support is present in the form of a nonwoven.

38. The amine-functionalized cellulose material according to claim 37, characterized in that the basis weight of the nonwoven is between about 150 and 600 g/m² and/or the thickness of the nonwoven is between about 0.5 and 15 mm.

39. The amine-functionalized cellulose material according to claim 34, characterized in that the polyalkylenamine is linear, branched, or cyclic.

40. The amine-functionalized cellulose material according to claim 34, characterized in that the polyalkylenamine is a polyethylenamine (PEI), polypropyleneamine, polybutyleneamine, polypentyleneamine, tetraethylenepentamine (TEPA), diethylenetriamine (DETA), and/or pentaethylenehexamine (PEHA).

41. The amine-functionalized cellulose material according to claim 34, characterized in that the polyalkylenamine has a molecular weight M_{w} of about 600 to 100,000.

42. The amine-functionalized cellulose material according to claim 34, characterized in that the crosslinked polyalkylenamine is based on a crosslinking of polyalkylenamine with a dialdehyde of the formula CHO(CH₂)ₙCH₂ CHO, wherein n is an integer between 2 and 9.

43. The amine-functionalized cellulose material according to claim 34, characterized in that the coating of the cellulose support with crosslinked polyalkylenamines has a thickness of about 0.1 to 10 μm.

44. Process A for producing the amine-functionalized cellulose material according to claim 34, characterized in that
1) the cellulose support is added to an alcoholic, solution of a compound crosslinking the polyalkylenamine, the crosslinking compound being at least bifunctional with respect to the crosslinking reaction and is present as a dialdehyde,
2) the polyalkylenamine is added to an alcoholic, solution, and
3) the alcoholic solutions from step 1) and step 2) are mixed,
4) water is added to the resulting mixture, in particular in an amount of about 10 to 40% by weight, based on the total reaction system, to start a crosslinking reaction, wherein a layer of a crosslinked polyalkylenamine is formed on the cellulose support, and
5) the amine-functionalized cellulose material is obtained after completion of the crosslinking reaction.

45. The process according to claim 44, characterized in that water is added in step 4) in such an amount that about 1 to 5 parts by weight of alcohol, are present per 1 part by weight of water.

46. The process according to claim 44, characterized in that the crosslinking reaction is carried out at a temperature of from about 15° C. to 50° C.

47. The process according to claim 44, characterized in that the obtained amine-functionalized cellulose material is dried at a temperature of from about 20° C. to 100° C., under a vacuum of from about 20 mbar to 300 mbar.

48. The process according to claim 44, characterized in that the amine-functionalized cellulose material obtained is washed at about 40° C. to 80° C., and dried again.

49. The process according to claim 48, characterized in that the washing is carried out in two steps, wherein in the first step, washing is done with water, and in the second step, washing is done with alcohol, to remove unreacted polyalkylenamine, followed by drying at elevated temperature.

50. The process according to claim 44, characterized in that about 5 to 50 parts by weight, of polyalkylenamine, are present per 1 part by weight of crosslinking compound.

51. The process according to claim 44, characterized in that the liquor ratio of cellulose support to the remaining cellulose coating batch is about 1:20 to 1:100.

52. Process B for producing the amine-functionalized cellulose material according to claim 34 with a textile fabric as cellulose support, in particular in the form of a nonwoven, characterized in that
1 the textile fabric is impregnated with an alcoholic, solution of a polyalkylenamine crosslinking compound (crosslinker) in form of a dialdehyde, in the dip tank of a padder machine, and the textile fabric impregnated in this way is pressed off in a subsequent pair of rollers of the padder machine, and
2 the wet, impregnated textile sheet structure of step 1 is then impregnated with an alcoholic in a further padding bath of the padder machine, and
said impregnated textile sheet structure obtained after steps 1 and 2 is pressed off over a further pair of rollers of the padder machine to a liquor pick-up of about 20 to 50% by weight, and
4 the crosslinking reaction between the crosslinker and the polyalkylenamine is then effected, if necessary, with heating, to form a layer of crosslinked polyalkylenamine on the surface of the textile sheet structure.

53. The process according to claim 52, characterized in that the pairs of rollers of the padder machine are operated at a speed of about 0.2 to 5 m/min, and/or the contact pressure of the rollers is set between about 0.2 and 5 bar.

54. The process according to claim 52, characterized in that the mass fraction of crosslinker in the liquor of step 1 is about 0.3 to 6% by weight, and/or the mass fraction of polyalkylenamine in the liquor of step 2 is about 3 to 18% by weight.

55. The process according to claim 52, characterized in that steps 1 and 2 are combined, and the textile sheet structure is treated with an impregnating solution containing the required reactants, and the impregnated textile sheet structure is subjected to steps 3 and 4 to form the amine-functionalized cellulose material.

56. The process according to claim 55, characterized in that the liquor ratio of textile sheet structure to a remaining coating composition batch is about 1:20 to 1:100.

57. The process according to claim 52, characterized in that about 5 to 50 parts by weight, of polyalkylenamine are present per 1 part by weight of (crosslinker).

58. The amine-functionalized cellulose material according claim 34, characterized in that the amine-functionalized cellulose material (adsorbent) has a CO₂ adsorption capacity of at least about 0.50 mmol_{CO2}/g_{adsorbent}.

59. The amine-functionalized cellulose material according to claim 58, characterized by an H₂O adsorption capacity of about 15 to 35% by weight.
